(19) United States
(12) Patent Application Publication
(10) Pub. No.: US 2025/0048232 A1
(43) Pub. Date: Feb. 6, 2025

(54) METHOD AND APPARATUS FOR NON-TERRESTRIAL NETWORK ACCESS MANAGEMENT

(71) Applicant: Samsung Electronics Co., Ltd., Gyeonggi-do (KR)

(72) Inventors: Deepanshu GAUTAM, Bangalore (IN); Ashutosh KAUSHIK, Bangalore (IN)

(21) Appl. No.: 18/792,119

(22) Filed: Aug. 1, 2024

(30) Foreign Application Priority Data
Aug. 1, 2023 (IN) 202341051716
Jul. 15, 2024 (IN) 202341051716

(51) Int. Cl. H04W 48/02; H04W 64/00; H04W 84/04; H04W 84/06

(52) U.S. Cl. CPC H04W 48/02; H04W 64/00; H04W 84/042; H04W 84/06

(57) ABSTRACT

The disclosure relates to a 5G or 6G communication system for supporting a higher data transmission rate. A method performed by an access and mobility management function (AMF) entity in a wireless communication system is provided. The method comprises receiving, from a managed function entity, information on a non-terrestrial network (NTN) public land mobile network (PLMN) restriction, wherein the information includes first information on an identity (ID) of public land mobile network (PLMN) and second information associated with a location for which an access of the PLMN is restricted for an NTN access and restricting the NTN access associated with the location based on the first information and the second information.

### CROSS-REFERENCE TO RELATED APPLICATION(S)

This application is based on and claims priority under 35 U.S.C. § 119 to Indian Provisional Patent Application No. 202341051716 and Indian Patent Application 202341051716, which were filed in the Indian Patent Office on Aug. 1, 2023, and Jul. 15, 2024, respectively, the disclosures of which are incorporated herein by reference in their entireties.

### BACKGROUND

### 1. Field

The disclosure relates generally to the field of new radio (NR) satellite access, and more particularly, to a method and a system for enhanced non-terrestrial network (NTN) management in NR satellite access.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) bands including 28 GHz and 39 GHz. In addition, it has been considered to implement sixth generation (6G) mobile communication technologies referred to as beyond 5G systems in terahertz (THz) bands, such as 95 GHz to 3 THz bands, to realize transmission rates fifty times faster than 5G mobile communication technologies and ultra-low latencies one-tenth of 5G mobile communication technologies.

At the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, NR-unlicensed (NR-U) aimed at system operations conforming to various regulation-related requirements in unlicensed bands, NR user equipment (UE) power saving, NTN which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying NR random access procedures. There also has been ongoing standardization in system architecture/service regarding a 5G service based architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above-mentioned problems and/or disadvantages and to provide at least the advantages described below.

Accordingly, an aspect of the disclosure is to provide a method and apparatus to configure an NTN to enable restrictions on UE access to a PLMN in NR.

A method performed by an access and mobility management function (AMF) entity in a wireless communication system is provided. The method comprises receiving, from a managed function entity, information on a non-terrestrial network (NTN) public land mobile network (PLMN) restriction, wherein the information includes first information on an identity (ID) of public land mobile network (PLMN) and second information associated with a location for which an access of the PLMN is restricted for an NTN access and restricting the NTN access associated with the location based on the first information and the second information.

An access and mobility management function (AMF) entity in a wireless communication system is provided. The AMF entity comprises a transceiver and a controller coupled with the transceiver and configured to receive, from a managed function entity, information on a non-terrestrial network (NTN) public land mobile network (PLMN) restriction, wherein the information includes first information on an identity (ID) of public land mobile network (PLMN) and second information associated with a location for which an access of the PLMN is restricted for an NTN access, and restrict the NTN access associated with the location based on the first information and the second information.

A method performed by a managed function entity in a wireless communication system is provided. The method comprises transmitting, to an access and mobility management function (AMF) entity, information on a non-terrestrial network (NTN) public land mobile network (PLMN) restriction, wherein the information includes first information on an identity (ID) of public land mobile network (PLMN) and second information associated with a location for which an access of the PLMN is restricted for an NTN access, and wherein a restriction of the NTN access associated with the location is based on the first information and the second information.

A managed function entity in a wireless communication system is provided. The managed function entity comprises a transceiver and a controller coupled with the transceiver and configured to transmit, to an access and mobility management function (AMF) entity, information on a non-terrestrial network (NTN) public land mobile network (PLMN) restriction, wherein the information includes first information on an identity (ID) of public land mobile network (PLMN) and second information associated with a location for which an access of the PLMN is restricted, and wherein a restriction of the NTN access associated with the location is based on the first information and the second information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an existing NTN system, according to an embodiment;

FIG. 2 illustrates a method for an NTN access management, according to an embodiment;

FIG. 3 illustrates a second management entity to manage the NTN access, according to an embodiment;

FIG. 4 illustrates a UE to manage the NTN access, according to an embodiment;

FIG. 5 illustrates a method that includes operations associated with the second management entity for configuring an Access and Mobility Management Function (AMF), according to an embodiment; and

FIG. 6 illustrates a method that includes operations associated with the AMF for transmitting an access response message to the UE, according to an embodiment.

FIG. 7 illustrates a structure of a network entity according to an embodiment of the present disclosure.

FIG. 8 illustrates a structure of a UE according to an embodiment of the disclosure.

FIG. 9 illustrates a structure of a base station according to an embodiment of the disclosure.

### DETAILED DESCRIPTION

The following description with reference to the accompanying drawings is provided to assist in a comprehensive understanding of various embodiments of the disclosure. It includes various specific details to assist in that understanding but these are to be regarded as examples.

Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

Elements in the drawings are illustrated for simplicity and may not have necessarily been drawn to scale. For example, the flow charts illustrate the method in terms of the most prominent steps involved to help to improve understanding of aspects of the disclosure. One or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

The foregoing general description and the following detailed description are explanatory of the invention and are not intended to limit the scope of the disclosure.

Reference throughout this specification to an aspect, another aspect or similar language means that a particular feature, structure, or characteristic described in connection with the embodiment is included in at least one embodiment of the disclosure. Thus, uses of the phrases in an embodiment, in one embodiment, in another embodiment, and similar language throughout this specification may, but do not necessarily, all refer to the same embodiment.

The terms comprise, comprising, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments.

The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Non-Terrestrial Network (NTN) provides non-terrestrial NR access to a User Equipment (UE) utilizing an NTN payload and an NTN gateway, depicting a service link between the NTN payload and the UE, and a feeder link between the NTN gateway and the NTN payload. The NTN payload transparently forwards a radio protocol received from the UE (via the service link) to the NTN gateway (via the feeder link) and vice-versa. The following connectivity is supported by the NTN payload: an NTN gateway may serve multiple NTN payloads, and an NTN payload may be served by multiple NTN gateways. Three types of service links are supported such as (1) Earth-fixed service link: provisioned by beam(s) continuously covering the same geographical areas all the time (e.g., the case of Geo Synchronous Orbit (GSO) satellites), (2) Quasi-earth-fixed service link: provisioned by beam(s) covering one geographic area for a limited period and a different geographic area during another period (e.g., the case of Non-Geostationary Orbit (NGSO) satellites generating steerable beams), and (3) Earth-moving service link provisioned by beam(s) whose coverage area slides over an earth surface (e.g., the case of NGSO satellites generating fixed or non-steerable beams). With the NGSO satellites, a gNodeB (gNB) can provide either the quasi-earth-fixed service link or the earth-moving service link, while the gNB operating with the GSO satellite can provide earth fixed service link.

The 5G system includes a 5G access network (AN), a 5G core network (CN), and the UE, according to the 3^{rd} generation partnership project (3GPP) technical specification (TS) 23.501. The 5G system is expected to be able to provide optimized support for a variety of different communication services, different traffic loads, and different end-user communities. For example, the communication services using network slicing may include V2X services. The 5G system aims to enhance its capability to meet key performance indicators (KPIs) that emerging V2X applications require. For advanced applications, the requirements, such as data rate, reliability, latency, communication range, and speed, are made more stringent, a 5G seamless eMBB as one of the key technologies to enable the network slicing, a fixed mobile convergence (FMC) which includes a wireless-to-the-everything (WTTx) and a fiber-to-the-everything (FTTx), is expected to provide native support for the network slicing.

For optimization and resource efficiency, the 5G system may select the most appropriate 3GPP or non-3GPP access technology for a communication service, potentially enabling multiple access technologies to be used simultaneously for one or more services active on the UE and massive Internet of things (mIoT) connections. Support for the mIoT creates many new requirements in addition to mobile broadband (MBB) enhancements. Communication services with mIoT connections such as smart households, smart grids, smart agriculture, and smart meters may require the support of many high-density IoT devices to be efficient and cost-effective. Operators can use one or more network slice instances to provide these communication services, which require similar network characteristics to different vertical industries. 3GPP TSs 28.530 and 28.531 define the management of network slices in 5G systems/networks and also define the concept of communication services, which are provided using one or more network slices. A network slice Instance (NSI) may support multiple communication service instances (CSIs). Similarly, the CSI may utilize multiple NSIs. A slice serves users in a particular geographical location known as a slice coverage area.

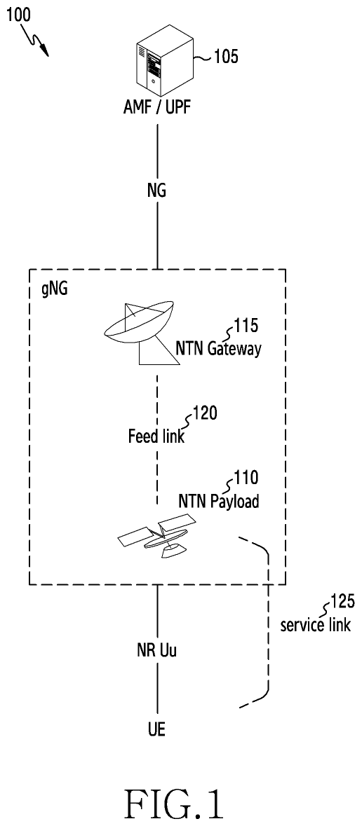

FIG. 1 illustrates an existing NTN system 100, according to an embodiment.

Referring to FIG. 1, the NTN provides non-terrestrial NR access to a UE utilizing an NTN payload 110 and an NTN gateway 115, depicting a service link between the NTN payload 110 and the UE, and a feeder link between the NTN gateway 115 and the NTN payload 110. The NTN payload 110 transparently forwards a radio protocol received from the UE, via the service link, to the NTN gateway 115, via the feeder link 120, and vice-versa. An NTN gateway 115 may serve multiple NTN payloads 110, and an NTN payload 110 may be served by multiple NTN gateways 115.

Three types of service links are supported, including an earth-fixed service link 125 provisioned by beam(s) continuously covering the same geographical areas, such as geo synchronous orbit (GSO) satellites, a quasi-earth-fixed service link provisioned by beam(s) covering one geographic area for a limited period and a different geographic area during another period, such as non-geostationary orbit (NGSO) satellites generating steerable beams, and an earth-moving service link provisioned by beam(s) having coverage area sliding over an earth surface, such as NGSO satellites generating fixed or non-steerable beams. With the NGSO satellites, a gNodeB (gNB) can provide either the quasi-earth-fixed service link or the earth-moving service link, while the gNB operating with the GSO satellite can provide earth fixed service link.

As previously noted, the NTN access may cover a large amount of area on earth spanning multiple countries, enabling the availability of a specific public land mobile network (PLMN) in those countries. This multi-country coverage may result in the imposition of various restrictions on the UE access to the PLMN, as outlined below. The existing network configuration mechanism lacks the capability to configure the network to enable all the aforementioned restrictions. These configurations are required to be implemented in a specific network node, such as the access and mobility management function (AMF) 105.

There may be scenarios where, even though the PLMN is available, the UEs are not permitted to connect to the network due to regulatory or operator-specific requirements. For instance, UEs from one country may not be allowed to connect to a home PLMN, even if the home PLMN is available when the UEs have roamed to another country.

In certain other scenarios, the UEs may not be allowed to connect to the PLMN from a specific location at a particular time. For example, the UEs' access to the PLMN may need to be restricted at location L1 at time T1 due to the movement of a Very Important Person (VVIP) at L1 during T1.

Additionally, the UEs may be allowed to access the PLMN but may not be permitted to utilize a particular service. For example, the UEs may be allowed to access the PLMN but may not be authorized to use one or more Ultra-Reliable and Low Latency Communications (URLLC) services due to constrained network resources.

The existing network configuration mechanism lacks the capability to comprehensively enforce the required access restrictions on the UEs in the NTN environment. This inflexibility can lead to suboptimal network utilization, potential service disruptions, and increased complexity due to the need for configurations in specific network nodes, impacting reliability and scalability. Thus, it is desired to address the above-mentioned disadvantages or other shortcomings or at least provide a useful alternative for NTN access management.

This summary is provided to introduce a selection of concepts, in a simplified format, that are further described in the detailed description of the invention. This summary is neither intended to identify key or essential inventive concepts of the invention nor is it intended for determining the scope of the invention.

According to an embodiment of the present disclosure, a method for Non-Terrestrial Network (NTN) access management is disclosed herein. The method includes receiving, by a second management entity, at least one of a create Managed Object Instance (MOI) request message and a modify MOI attributes message from a first management entity, the create MOI request message and the modify MOI attributes message comprises NTN PLMN restrictions information. Further, the method includes transmitting, by the second management entity, at least one of a create MOI attributes response message to the first management entity in response to receiving the create MOI request message and a modify MOI attributes response message to the first management entity in response to receiving the modify MOI attributes message. Furthermore, the method includes configuring, by the second management entity, at least one Access and Mobility Management Function (AMF) based on the received NTN PLMN restrictions information for the NTN access management.

According to another embodiment of the present disclosure, a method for Non-Terrestrial Network (NTN) access management is disclosed herein. The method includes receiving, by an Access and Mobility Management Function (AMF), an access request from a User Equipment (UE) to enable an NTN access, wherein the AMF is configured with NTN PLMN restrictions information, the access request indicates at least one of a location of the UE, and the AMF identifies the location of the UE in response to the received access request. Further, the method includes transmitting, by the AMF, an access response message to the UE based on the configured NTN PLMN restriction in response to the received access request.

According to one embodiment of the present disclosure, a system for the Non-Terrestrial Network (NTN) access management is disclosed herein. The system includes a processor, a memory, a communicator, and a Non-Terrestrial Network (NTN) access management module. At least one processor operably connected to the memory and a communicator, the at least one processor configured to receive, using a second management entity, at least one of a create Managed Object Instance (MOI) request message and a modify MOI attributes message from a first management entity, wherein the create MOI request message and the modify MOI attributes message comprises NTN PLMN restrictions information. Further, the at least one processor is configured to transmit, using the second management entity, at least one of a create MOI attributes response message to the first management entity in response to receiving the create MOI request message and a modify MOI attributes response message to the first management entity in response to receiving the modify MOI attributes message. Furthermore, the at least one processor configures, using the second management entity, at least one Access and Mobility Management Function (AMF) based on the received NTN PLMN restrictions information for the NTN access management.

According to another embodiment of the present disclosure, a system for the Non-Terrestrial Network (NTN) access management is disclosed herein. The system includes a memory, at least one processor operably connected to the memory, a communicator, and an NTN access management module. The at least one processor configured to receive, using an Access and Mobility Management Function (AMF), an access request from a User Equipment (UE) to enable an NTN access, the AMF is configured with NTN PLMN restrictions information, wherein the access request indicates at least one of a location of the UE, and the AMF identifies the location of the UE in response to the received access request. The at least one processor is configured to transmit, using the AMF, an access response message to the UE based on the configured NTN PLMN restriction in response to the received access request.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

According to one embodiment of the present disclosure, a method for a Non-Terrestrial Network (NTN) access management is disclosed herein. The method includes configuring a set of information in an AMF, as shown below in Table 1. The set of information may include a PLMN identification, a blocked location, a blocked duration, and a blocked slice/service. The new set of information may enable NTN access restrictions to be enforced by a network.

TABLE 1
The information providing details of which PLMNs access restrictions to be applied

| | |
|---|---|
| PLMN | The identification of the PLMN for which the restrictions are provided. |
| identification | |
| Blocked | Providing the geographical location where the PLMN is not allowed to |
| location | operate. |
| Blocked | Providing the time duration for which the PLMN is not allowed to operate at a |
| duration | particular geographical location. |
| Blocked | Providing the slice for which the PLMN is not allowed to operate at a |
| slice/service | particular geographical location e.g., eMBB, URLLC. Providing a specific |
| | Domain Name (DN) of a particular Network Slice or Slice Service Type |
| | (SST). When the SST is provided none of the slices of provided SST may be |
| | allowed. |

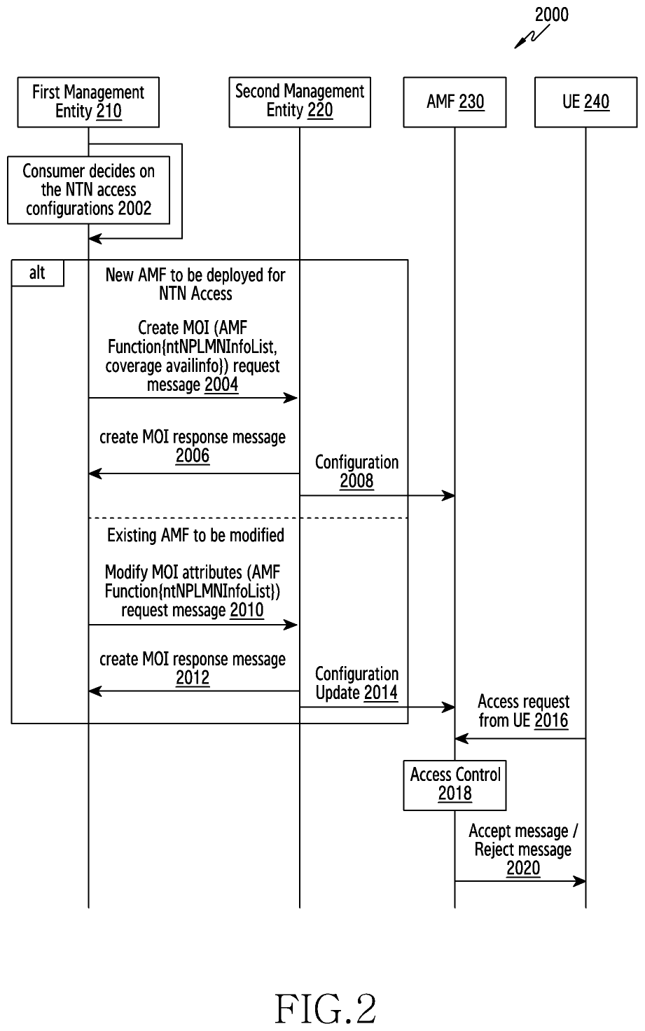

Reference is now made to the drawings, and more specifically to FIGS. 2 to 6, where similar reference characters consistently represent equivalent aspects throughout the figures.

FIG. 2 illustrates a method 2000 for the NTN access management, according to an embodiment.

Referring to FIG. 2, in step 2002, a consumer determines NTN access configurations, which may include NTN access and NTN access restrictions to be enforced by a network. The network may be a 5G core network.

The AMF 230 is to be deployed for the NTN access using the following operations. In step 2004, a second management entity 220 may receive a create managed object instance (MOI) (AMF function{ntNPLMNInfoList, coverage availinfo}) request message from a first management entity 210. The create MOI request message may include NTN PLMN restrictions information. The first management entity 210 may be a provisioning management service (Mns) consumer, and the second management entity 220 may be a provisioning Mns producer.

The NTN PLMN restrictions information may include the PLMN identification, the blocked location, the blocked duration, the blocked slice, an NTNPLMN information list attribute, a blocked location information list attribute, a blocked location attribute, a blocked duration window attribute, a blocked duration start-time attribute, a blocked duration end-time attribute, and a blocked slice attribute. The NTNPLMN information list attribute may indicate location restrictions per PLMN that relate to NTN access. The blocked location information list attribute may indicate information related to the location for which the access restrictions are to be applied in the case of the NTN. The blocked location attribute may indicate a geographical location at which the PLMN is not allowed in the case of the NTN. The blocked duration window attribute may indicate a time duration for which the PLMN is not allowed at a given location in the case of the NTN. The blocked duration start-time attribute may indicate a start time starting which the PLMN is not allowed at the given location in the case of the NTN. The blocked duration end-time attribute may indicate an end time after which the PLMN is not allowed at the given location in the case of the NTN. The blocked slice attribute may indicate a slice for which access is not allowed at the given location in the case of the NTN. The NTN PLMN restriction information may enable the NTN access to be enforced by the second management entity 220.

In step 2006, the second management entity 220 may transmit a create MOI attributes (AMF function{ntNPLMNInfoList}) response message to the first management entity 210 in response to receiving the create MOI request message. In step 2008, the second management entity 220 may configure an AMF 230 based on the received NTN PLMN restrictions information for the NTN access management.

An existing AMF 230 is modified for the NTN access using the following operations. In step 2010, the second management entity 220 may receive a modify MOI request message from the first management entity 210. The modify MOI request message may include NTN PLMN restrictions information. In step 2012, the second management entity 220 may transmit a modify MOI attributes response message to the first management entity 210 in response to receiving the modify MOI request message. In step 2014, the second management entity 220 may update the existing AMF 230 based on the received NTN PLMN restrictions information for the NTN access management.

In step 2016, the AMF 230 may receive an access request from a UE 240 to access NTN. The AMF 230 may be configured with NTN PLMN restrictions information. The access request may indicate a location of the UE 240, or the AMF 230 may identify the location of the UE 240 in response to the received access request. The AMF 230 may be configured to determine whether to allow the UE 240 to access the network or not based on the location of the UE 240 and the NTN PLMN restrictions information.

In step 2018, the AMF 230 may perform the access control. In step 2020, the AMF 230 may transmit an access response message to the UE 240 based on the configured NTN PLMN restriction in response to the received access request. The access response message may include, but is not limited to, an accept message, a reject message, and the like.

The AMF function information object classes (IOC) may include attributes inherited from managed function IOC and the following attributes as shown below in Table 2:

TABLE 2

| Attribute name | S | isReadable | isWritable | isInvariant | isNotifyable |
|---|---|---|---|---|---|
| PLMNInfoList | M | T | T | F | T |
| aMFIdentifier | M | T | T | F | T |
| sBIFQDN | M | T | T | F | T |
| interPlmnFQDN | O | T | T | F | T |
| cNSIIdList | C | T | F | F | T |
| | M | | | | |
| managedNFProfile | M | T | T | F | T |
| commModelList | M | T | T | F | T |
| amfInfo | M | T | T | F | T |
| nTNPLMNRestrictionsList | M | T | T | F | T |
| satelliteCoverageInfoList | C | T | T | F | T |
| | M | | | | |
| Attribute related | | | | | |
| to role | | | | | |
| aMFSetRef | M | T | T | F | T |

The information shown below in Table 3 and Table 4 provides network resource model (NRM) definitions required for the above-described solution. The nTNPLMNInfoList attribute may be added to the AMF Function Information Object Classes (JOC). The attribute may be of type NTNPLMNRestrictionsInfo <<data type>>. This data type may define the location restrictions per the PLMN that relate to non-terrestrial network access.

TABLE 3

| Attribute | | Is | Is | Is | | | |
|---|---|---|---|---|---|---|---|
| name | Support | Readable | Writable | Invariant | isNotifyable | Cardinality | Description |
| pLMNId | M | T | T | F | T | 1 | This identifies the |
| | | | | | | | PLMN. |
| blockedLocationInfo | M | T | T | F | T | 1 . . . * | This defines the |
| List | | | | | | | information related |
| | | | | | | | to the location for |
| | | | | | | | which the access |
| | | | | | | | restrictions are to be |
| | | | | | | | applied in the case |
| | | | | | | | of NTN. |

The blocked location information list attribute may be of type BlockedLocationInfo <<data type>>. This datatype may define the information related to the location for which the PLMN access restrictions are to be applied in the case of the NTN.

TABLE 4

| Attribute | | Is | Is | Is | Is | | |
|---|---|---|---|---|---|---|---|
| Name | Support | Readable | Writable | Invariant | Notifyable | Cardinality | Description |
| blockedLocation | M | T | T | F | T | 1 | This attribute provides |
| | | | | | | | the geographical |
| | | | | | | | location at which the |
| | | | | | | | PLMN is not allowed |
| | | | | | | | in the case of NTN. |
| blockedDur | M | T | T | F | T | 1 | This attribute provides |
| | | | | | | | the time duration for |
| | | | | | | | which the PLMN is not |
| | | | | | | | allowed at a given |
| | | | | | | | location in the case of |
| | | | | | | | NTN. |
| blockedSlice | M | | T | F | T | 1 | This attribute provides |
| | | | | | | | the slice for which |
| | | | | | | | access is not allowed at |
| | | | | | | | a given location in the |
| | | | | | | | case of NTN. |

The NTN PLMN restrictions Information list attribute may provide details on the NTN access restrictions to be enforced in the network.

Table 5 below may define the attributes that are present in several information object classes (IOCs).

TABLE 5

| | Documentation and Allowed | |
|---|---|---|
| Attribute Name | Values | Properties |
| nTNPLMNInfoList | This attribute may define the | type: |
| | location restrictions per PLMN | NTNPLMNRestrictionsInfo |
| | that relate to non-terrestrial | multiplicity: 1 . . . * |
| | network access. | isOrdered: False |
| | | isUnique: True |
| | | defaultValue: None |
| | | isNullable: True |
| blockedLocationInfoList | This attribute may define the | type: BlockedLocationInfo |
| | information related with the | multiplicity: 1 . . . * |
| | location for which the access | isOrdered: False |
| | restrictions are to be applied in | isUnique: True |
| | case of NTN. | defaultValue: None |
| | | isNullable: True |
| blockedLocation | This attribute may provide the | type: string |
| | geographical location at which | multiplicity: 1 |
| | the PLMN is not allowed in | isOrdered: N/A |
| | case of NTN. | isUnique: N/A |
| | | defaultValue: None |
| | | isNullable: True |
| blockedDurWindow | This attribute may provide the | type: TimeWindow |
| | time durations for which the | multiplicity: * |
| | PLMN is not allowed at a given | isOrdered: N/A |
| | location in the case of NTN. | isUnique: N/A |
| | | defaultValue: None |
| | | isNullable: True |
| blockedDurStartTime | This attribute may provide the | type: DateTimeultiplicity: 1 |
| | start time starting which the | isOrdered: N/A |
| | PLMN is not allowed at a given | isUnique: N/A |
| | location in the case of NTN. | defaultValue: None |
| | | isNullable: True |
| blockedDurEndTime | This attribute may provide the | type: DateTime |
| | end time after which the PLMN | multiplicity: 1 |
| | is not allowed at a given | isOrdered: N/A |
| | location in the case of NTN. | isUnique: N/A |
| | | defaultValue: None |
| | | isNullable: True |
| blockedSlice | This attribute may provide the | type: String |
| | slice for which the access is not | multiplicity: 1 |
| | allowed at a given location in | isOrdered: N/A |
| | the case of NTN. | isUnique: N/A |
| | | defaultValue: None |
| | | isNullable: True |

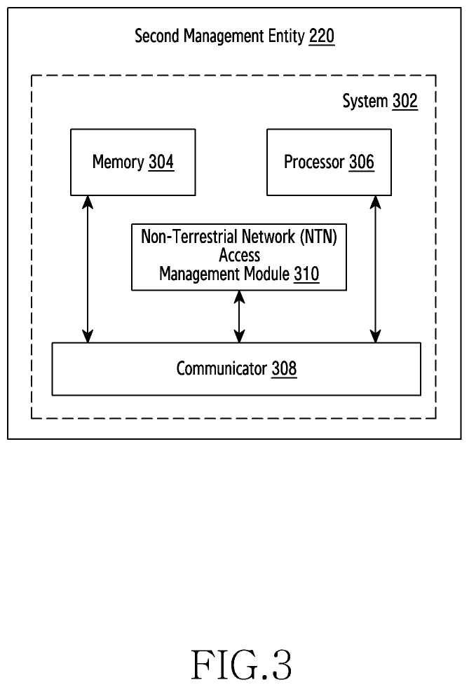

FIG. 3 illustrates the second management entity 220 to manage the NTN access, according to an embodiment.

Referring to FIG. 3, the second management entity 200 may include a system 302. The system 302 may include a memory 304, a processor 306, a communicator 308, and an NTN access management module 310. The system 302 may be implemented on one or multiple electronic devices.

The memory 304 may store instructions to be executed by the processor 306 for managing the NTN access, as discussed herein. The memory 304 may include non-volatile storage elements such as magnetic hard discs, optical discs, floppy discs, flash memories, or forms of electrically programmable memories (EPROM) or electrically erasable and programmable (EEPROM) memories. The memory 304 may be considered a non-transitory storage medium, wherein the term “non-transitory” may indicate that the storage medium is not embodied in a propagated signal but should not be interpreted as the memory 304 being non-movable. In some examples, the memory 304 can be configured to store larger amounts of information. A non-transitory storage medium may store data that can, over time, change (e.g., in random access memory (RAM) or cache). The memory 304 can be an internal storage unit, or it can be an external storage unit of the AMF 230, a cloud storage, or any other type of external storage.

The processor 306 may communicate with the memory 304 and the communicator 308. The processor 306 may be configured to execute instructions stored in the memory 304 and to perform various processes for the NTN access management, as discussed herein. The processor 306 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an AI dedicated processor such as a neural processing unit (NPU).

The NTN access management module 310 may perform one or more operations to manage the NTN access, as described below.

The NTN access management module 310 may receive the create MOI request message or the modify MOI attributes message using the second management entity 220 from the first management entity 210, which may relate to steps 2004 and 2010 in FIG. 2. The NTN access management module 310 may transmit the create MOI attributes response message using the second management entity 220 to the first management entity 210 in response to receiving the create MOI request message and the modify MOI attributes response message to the first management entity 210 in response to receiving the modify MOI attributes message, which may relate to steps 2006 and 2012 in FIG. 2. The NTN access management module 310 may configure the AMF 230 based on the received NTN PLMN restrictions information for the NTN access management, which may relate to steps 2008 and 2014 in FIG. 2.

The communicator 308 may be configured for communicating internally between internal hardware components and with external devices (e.g., a server, etc.) via one or more networks (e.g., radio technology). The communicator 308 includes an electronic circuit specific to a standard that enables wired or wireless communication.

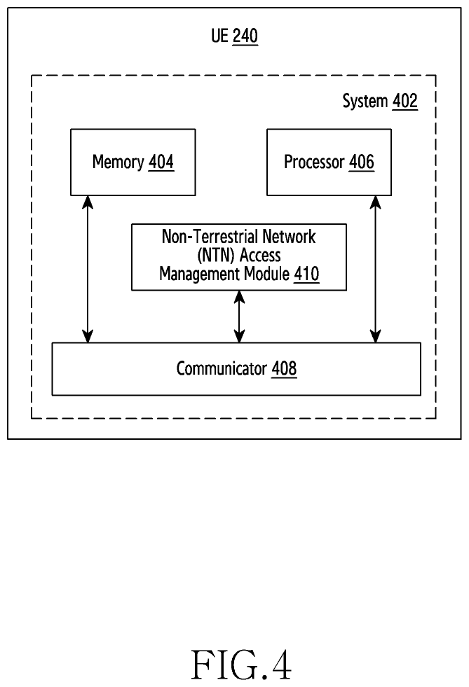

Although FIG. 3 illustrates various hardware components of the second management entity 220, but it is to be understood that other embodiments are not limited thereon. In other embodiments, the second management entity 220 may include less or more number of components. Further, the labels or names of the components are used only for illustrative purposes and do not limit the scope of the invention. One or more components can be combined to perform the same or substantially similar functions to establish the formalized federation. FIG. 4 illustrates the UE 240 to manage the NTN access, according to an embodiment. The UE 240 may refer to any device such as smartphones, tablets, IoT devices, or other endpoints that connect to the network.

Referring to FIG. 4, the UE 240 may include the system 402 which includes a memory 404, a processor 406, a communicator 408, and an NTN access management module 410. The system 402 may be implemented on one or multiple electronic devices.

The memory 404 may store instructions to be executed by the processor 406 for NTN access management, as discussed herein. The memory 404 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 404 may, in some examples, be considered a non-transitory storage medium. The term “non-transitory” may indicate that the storage medium is not embodied in a carrier wave or a propagated signal. However, the term “non-transitory” should not be interpreted that the memory 404 is non-movable. In some examples, the memory 404 can be configured to store larger amounts of information than the memory. In certain examples, a non-transitory storage medium may store data that can, over time, change (e.g., in Random Access Memory (RAM) or cache). The memory 404 can be an internal storage unit, or it can be an external storage unit of the UE 240, a cloud storage, or any other type of external storage.

The processor 406 may communicate with the memory 404 and the communicator 230. The processor 406 is configured to execute instructions stored in the memory 404 and to perform various processes for NTN access management, as discussed herein. The processor 406 may include one or a plurality of processors, may be a general-purpose processor, such as a central processing unit (CPU), an application processor (AP), or the like, a graphics-only processing unit such as a graphics processing unit (GPU), a Visual Processing Unit (VPU), and/or an AI dedicated processor such as an NPU.

The NTN access management module 410 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The NTN access management module 410 may perform one or more operations to manage the NTN access, which is described below.

The NTN access management module 410 may receive the access request using the AMF 230 from the UE 240 to access the NTN, which may relate to step 2016 in FIG. 2. The AMF 230 may be configured with NTN PLMN restrictions information, the access request may indicate the location of the UE 240, and the AMF 230 may identify the location of the UE 240 in response to the received access request. The NTN access management module 410 may transmit the access response message to the UE 240 using the AMF 230 based on the configured NTN PLMN restriction in response to the received access request, which may relate to step 2018 in FIG. 2.

The communicator 408 is configured for communicating internally between internal hardware components and with external devices (e.g., server) via one or more networks (e.g., radio technology). The communicator 408 may include an electronic circuit specific to a standard that enables wired or wireless communication.

Although FIG. 4 illustrates various hardware components of the UE 240, but it is to be understood that other embodiments are not limited thereon. In other embodiments, the UE 240 may include less or more number of components. Further, the labels or names of the components are used only for illustrative purposes and do not limit the scope of the invention. One or more components can be combined to perform the same or substantially similar functions to establish the formalized federation.

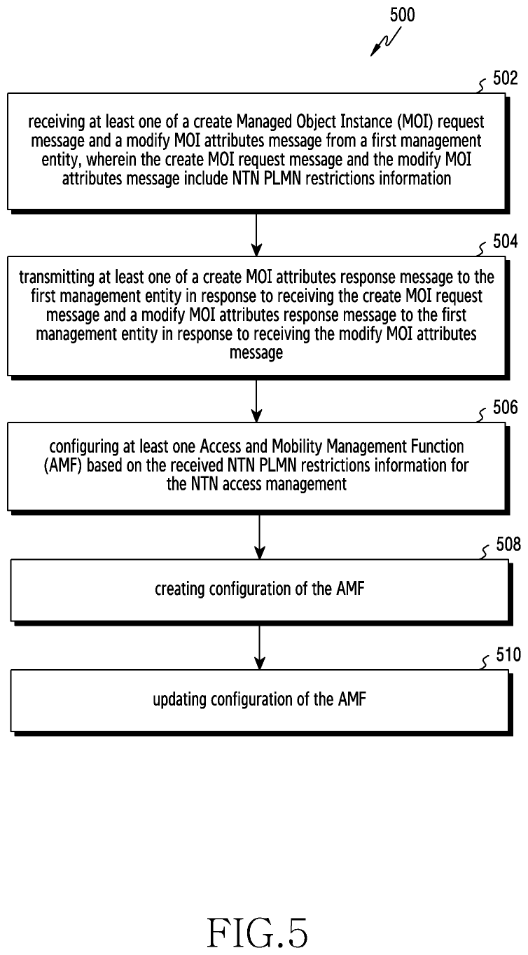

FIG. 5 illustrates a method 500 associated with the second management entity 220 for configuring the AMF 220, according to an. embodiment.

In step 502, the method 500 may include receiving, by the second management entity 220, at least one of a create MOI request message and a modify MOI attributes message from the first management entity 210. The create MOI request message and the modify MOI attributes message may include NTN PLMN restrictions information.

In step 504, the method 500 may include transmitting, by the second management entity 220, at least one of the create MOI attributes response message to the first management entity 210 in response to receiving the create MOI request message and the modify MOI attributes response message to the first management entity 210 in response to receiving the modify MOI attributes message.

In step 506, the method 500 may include configuring, by the second management entity 220, the AMF 230 based on the received NTN PLMN restrictions information for the NTN access management.

In step 508, the method 500 may include creating, by the second management entity 220, the configuration of the AMF 230.

In step 510, method 500 may include updating, by the second management entity 220, the configuration of the AMF 230. A detailed description related to the steps of FIG. 5 is covered in the description related to FIG. 2 and is omitted herein for the sake of conciseness.

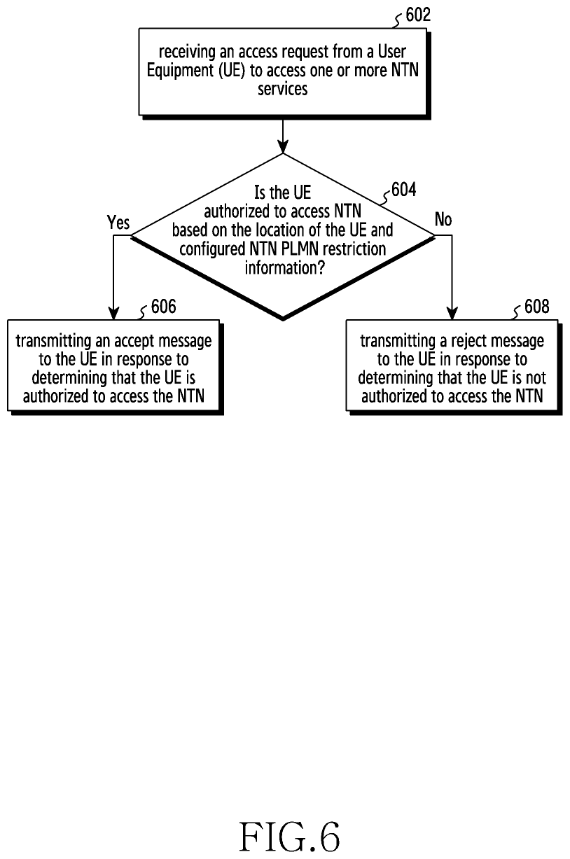

FIG. 6 illustrates a method 600 associated with the AMF 230 for transmitting the access response message to the UE 240, according to an embodiment.

In step 602, the method 600 may include receiving, by the AMF 230, an access request from the UE 240 to access the NTN. The AMF 230 may be configured with NTN PLMN restrictions information. The access request may indicate at least one of the location of the UE 240, and the AMF 230 identifies the location of the UE 240 in response to the received access request.

In step 604, the method 600 may include determining whether the UE 240 authorized to access, by the AMF 230, the NTN based on the location of the UE 240 and the configured NTN PLMN restriction information. If YES, in step 606, the method 600 may include transmitting, by the AMF 230, an accept message to the UE 240 in response to determining that the UE 240 is authorized to access the NTN. If NO, in step 608, the method 600 includes transmitting, by the AMF 230, a reject message to the UE 240 in response to determining that the UE 240 is not authorized to access the NTN. Further, a detailed description related to the various steps of FIG. 6 is covered in the description related to FIG. 2 and is omitted herein for the sake of brevity.

The methods as described herein include several advantages which may enable enforcement of the following NTN access restriction for the UE, which are mentioned below.

The UEs are not allowed to access PLMN from a particular location even if the PLMN is available.

The UEs are not allowed to access PLMN from a particular location for a given time duration even if the PLMN is available.

The UEs are not allowed to access PLMN from a particular location for a particular slice or service even if the PLMN is available.

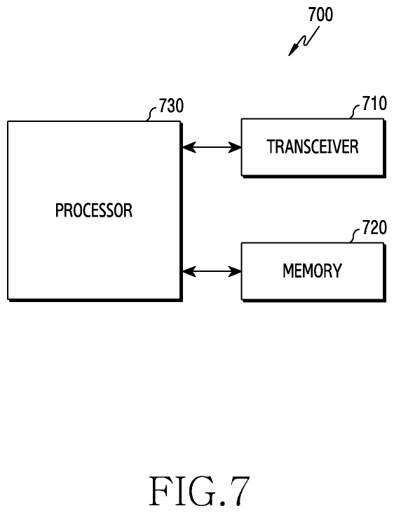

FIG. 7 illustrates a structure of a network entity according to an embodiment of the present disclosure.

As shown in FIG. 7, the network entity of the present disclosure may include a transceiver 710, a memory 720, and a processor 730. The transceiver 710, the memory 720, and the processor 730 of the network entity may operate according to a communication method of the network entity described above. However, the components of the terminal are not limited thereto. For example, the network entity may include more or fewer components than those described above. In addition, the processor 730, the transceiver 710, and the memory 720 may be implemented as a single chip. Also, the processor 730 may include at least one processor.

For example, the network entity of FIG. 7 corresponds to the AMF of the FIG. 1 to FIG. 6.

The transceiver 710 collectively refers to a network entity receiver and a network entity transmitter and may transmit/receive a signal to/from a base station or a UE. The signal transmitted or received to or from the base station or the UE may include control information and data. In this regard, the transceiver 710 may include an RF transmitter for up-converting and amplifying a frequency of a transmitted signal, and an RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the network entity. Also, the memory 720 may store control information or data included in a signal obtained by the network entity. The memory 720 may be a storage medium, such as ROM, RAM, a hard disk, a CD-ROM, and a DVD, or a combination of storage media.

The processor 730 may control a series of processes such that the network entity operates as described above. For example, the transceiver 710 may receive a data signal including a control signal, and the processor 730 may determine a result of receiving the data signal.

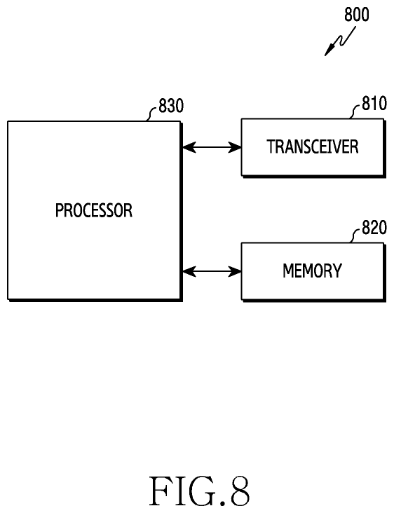

FIG. 8 illustrates a structure of a UE according to an embodiment of the disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor. Furthermore, the UE of FIG. 8 corresponds to the UE of the FIG. 1 to FIG. 6, respectively.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include an RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

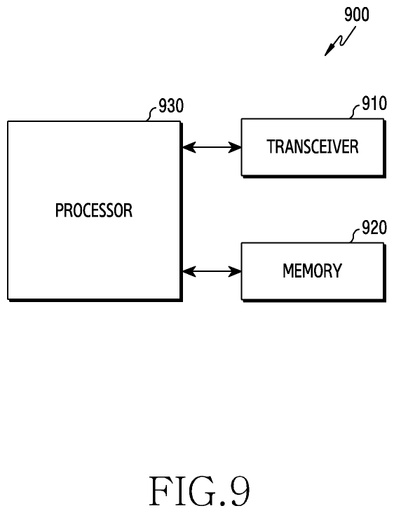

FIG. 9 illustrates a structure of a base station according to an embodiment of the disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor. Furthermore, the base station of FIG. 9 corresponds to base station of FIG. 1 to FIG. 6.

The transceiver 910 collectively refers to a base station receiver and a base station transmitter and may transmit/receive a signal to/from a terminal (UE) or a network entity. The signal transmitted or received to or from the terminal or a network entity may include control information and data. The transceiver 910 may include an RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

As described above, a method for NTN access management includes receiving, by a second management entity, at least one of a create Managed Object Instance (MOI) request message and a modify MOI attributes message from a first management entity, wherein the create MOI request message and the modify MOI attributes message comprises NTN PLMN restrictions information, transmitting, by the second management entity, at least one of a create MOI attributes response message to the first management entity in response to receiving the create MOI request message and a modify MOI attributes response message to the first management entity in response to receiving the modify MOI attributes message and configuring, by the second management entity, at least one AMF based on the received NTN PLMN restrictions information for the NTN access management.

The NTN PLMN restrictions information comprises at least one of a PLMN identification, a blocked location, a blocked duration, a blocked slice, at least one NTNPLMN information list attribute indicates location restrictions per PLMN that relate to a non-terrestrial network access, at least one blocked location information list attribute indicates information related to the location for which the access restrictions are to be applied in case of the NTN, at least one blocked location attribute indicates a geographical location at which the PLMN is not allowed in the case of the NTN, at least one blocked duration window attribute indicates a time duration for which the PLMN is not allowed at a given location in the case of the NTN, at least one blocked duration start-time attribute indicates a start time starting which the PLMN is not allowed at the given location in the case of the NTN, at least one blocked duration end-time attribute indicates an end time after which the PLMN is not allowed at the given location in the case of the NTN, and at least one blocked slice attribute indicates a slice for which access is not allowed at the given location in the case of the NTN.

The method further comprises creating, by the second management entity, configuration of the AMF.

The method further comprises updating, by the second management entity, configuration of the AMF.

The NTN PLMN restriction information enables an NTN access to be enforced by the second management entity.

A method for NTN access management includes receiving, by an AMF, an access request from a UE to enable an NTN access, wherein the AMF is configured with NTN PLMN restrictions information, wherein the access request indicates at least one of a location of the UE, and the AMF identifies the location of the UE in response to the received access request, and transmitting, by the AMF, an access response message to the UE based on the configured NTN PLMN restriction in response to the received access request.

Transmitting the access response message to the UE comprises determining, by the AMF, whether the UE is authorized to access the NTN based on the location of the UE and the configured NTN PLMN restriction information, an, performing, by the AMF, one of transmitting an accept message to the UE in response to determining that the UE is authorized to access the NTN or transmitting a reject message to the UE in response to determining that the UE is not authorized to access the NTN.

A system for NTN access management includes a memory, an NTN access management module, at least one processor operably connected to the memory and a communicator, the at least one processor configured to receive, using a second management entity, at least one of a create MOI request message and a modify MOI attributes message from a first management entity, wherein the create MOI request message and the modify MOI attributes message comprises NTN PLMN restrictions information, transmit, using the second management entity, at least one of a create MOI attributes response message to the first management entity in response to receiving the create MOI request message and a modify MOI attributes response message to the first management entity in response to receiving the modify MOI attributes message and configure, using the second management entity, at least one AMF based on the received NTN PLMN restrictions information for the NTN access management.

The NTN PLMN restrictions information includes at least one of a PLMN identification, a blocked location, a blocked duration, a blocked slice, at least one NTNPLMN information list attribute indicates location restrictions per PLMN that relate to a non-terrestrial network access, at least one blocked location information list attribute indicates information related to the location for which the access restrictions are to be applied in case of the NTN, at least one blocked location attribute indicates a geographical location at which the PLMN is not allowed in the case of the NTN, at least one blocked duration window attribute indicates a time duration for which the PLMN is not allowed at a given location in the case of the NTN, at least one blocked duration start-time attribute indicates a start time starting which the PLMN is not allowed at the given location in the case of the NTN, at least one blocked duration end-time attribute indicates an end time after which the PLMN is not allowed at the given location in the case of the NTN, and at least one blocked slice attribute indicates a slice for which access is not allowed at the given location in the case of the NTN.

The at least one processor is configured to create, using the second management entity, configuration of the AMF.

The at least one processor is configured to update, using the second management entity, configuration of the AMF.

The NTN PLMN restriction information enables NTN access to be enforced by the second management entity.

A system for NTN access management includes a memory, an NTN access management module, at least one processor operably connected to the memory and a communicator (408), the at least one processor configured to receive, using an AMF, an access request from a UE to enable an NTN access, wherein the AMF is configured with NTN PLMN restrictions information, wherein the access request indicates at least one of a location of the UE, and the AMF identifies the location of the UE in response to the received access request and transmit, using the AMF, an access response message to the UE based on the configured NTN PLMN restriction in response to the received access request.

At least one processor is configured to determine, using the AMF, whether the UE is authorized to access the NTN based on the location of the UE and the configured NTN PLMN restriction information, and perform, using the AMF, one of transmit an accept message to the UE in response to determining that the UE is authorized to access the NTN or transmit a reject message to the UE in response to determining that the UE is not authorized to access the NTN.

The various actions, acts, blocks, steps, or the like in the flow diagrams may be performed in the order presented, in a different order, or simultaneously. Some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this invention pertains. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

Embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by an access and mobility management function (AMF) entity in a wireless communication system, the method comprising:
receiving, from a managed function entity, information on a non-terrestrial network (NTN) public land mobile network (PLMN) restriction, wherein the information includes first information on an identity (ID) of public land mobile network (PLMN) and second information associated with a location for which an access of the PLMN is restricted for an NTN access; and
restricting the NTN access associated with the location based on the first information and the second information.

2. The method of claim 1, wherein the second information further includes geographical information on the location at which the PLMN is not allowed for the NTN access.

3. The method of claim 1, wherein the second information further includes information on a time duration for which the PLMN is not allowed for the NTN access at the location, and information on a network slice for which the PLMN is not allowed for the NTN access at the location.

4. The method of claim 1, wherein the information on the NTN PLMN restriction includes location restrictions per PLMN associated with the NTN access.

5. The method of claim 1, further comprising:
receiving, from a base station, a message including information on a location of a user equipment (UE) associated with the NTN access; and
identifying whether the UE is allowed to operate at the location of the UE.

6. An access and mobility management function (AMF) entity in a wireless communication system, the AMF entity comprising:
a transceiver; and
a controller coupled with the transceiver and configured to:
receive, from a managed function entity, information on a non-terrestrial network (NTN) public land mobile network (PLMN) restriction, wherein the information includes first information on an identity (ID) of public land mobile network (PLMN) and second information associated with a location for which an access of the PLMN is restricted for an NTN access, and
restrict the NTN access associated with the location based on the first information and the second information.

7. The AMF entity of claim 6, wherein the second information further includes geographical information on the location at which the PLMN is not allowed for the NTN access.

8. The AMF entity of claim 6, wherein the second information further includes information on a time duration for which the PLMN is not allowed for the NTN access at the location, and information on a network slice for which the PLMN is not allowed for the NTN access at the location.

9. The AMF entity of claim 6, wherein the information on the NTN PLMN restriction includes location restrictions per PLMN associated with the NTN access.

10. The AMF entity of claim 6, wherein the controller is further configured to:
receive, from a base station, a message including information on a location of a user equipment (UE) associated with the NTN access, and
identify whether the UE is allowed to operate at the location of the UE.

11. A method performed by a managed function entity in a wireless communication system, the method comprising:
transmitting, to an access and mobility management function (AMF) entity, information on a non-terrestrial network (NTN) public land mobile network (PLMN) restriction,
wherein the information includes first information on an identity (ID) of public land mobile network (PLMN) and second information associated with a location for which an access of the PLMN is restricted for an NTN access, and
wherein a restriction of the NTN access associated with the location is based on the first information and the second information.

12. The method of claim 11, wherein the second information further includes geographical information on the location at which the PLMN is not allowed for the NTN access.

13. The method of claim 11, wherein the second information further includes information on a time duration for which the PLMN is not allowed for the NTN access at the location.

14. The method of claim 11, wherein the second information further includes information on a network slice for which the PLMN is not allowed for the NTN access at the location.

15. The method of claim 11, wherein the information on the NTN PLMN restriction includes location restrictions per PLMN associated with the NTN access.

16. A managed function entity in a wireless communication system, the managed function entity comprising:
a transceiver; and
a controller coupled with the transceiver and configured to:
transmit, to an access and mobility management function (AMF) entity, information on a non-terrestrial network (NTN) public land mobile network (PLMN) restriction,
wherein the information includes first information on an identity (ID) of public land mobile network (PLMN) and second information associated with a location for which an access of the PLMN is restricted, and
wherein a restriction of the NTN access associated with the location is based on the first information and the second information.

17. The managed function entity of claim 16, wherein the second information further includes geographical information on the location at which the PLMN is not allowed for the NTN access.

18. The managed function entity of claim 16, wherein the second information further includes information on a time duration for which the PLMN is not allowed for the NTN access at the location.

19. The managed function entity of claim 16, wherein the second information further includes information on a network slice for which the PLMN is not allowed for the NTN access at the location.

20. The managed function entity of claim 16, wherein the information on the NTN PLMN restriction includes location restrictions per PLMN associated with the NTN access.
